(19) United States
(12) Patent Application Publication
(10) Pub. No.: US 2017/0326586 A1
(43) Pub. Date: Nov. 16, 2017

(54) METHOD AND DEVICE FOR COATING THE INNER SURFACE OF A CONTAINER AND CONTAINER OBTAINED WITH SUCH A METHOD

(71) Applicant: GLASS SURFACE TECHNOLOGY, Paris (FR)

(72) Inventors: Christophe Wagner, Paris (FR); Antoine Bauvin, Quesnoy Le Montant (FR)

(73) Assignee: GLASS SURFACE TECHNOLOGY, Paris (FR)

(21) Appl. No.: 15/529,720

(22) PCT Filed: Nov. 26, 2015
(86) PCT No.: PCT/FR2015/053225

§ 371 Date: May 25, 2017

(30) Foreign Application Priority Data
Nov. 26, 2014 (FR) 1461529

(51) Int. Cl. B05D 7/22; B05D 1/00; B05D 3/02; B05D 3/04

(52) U.S. Cl. CPC B05D 7/227; B05D 3/042; B05D 1/002; B05D 3/0218

(57) ABSTRACT

A method for coating at least one portion of the inner surface of a container with a curable liquid material, a device for implementing said method; and a container obtained by said method. The container is positioned on a holder and secured thereto; a tool for applying the coating is inserted into the container and the coating liquid is applied using the tool on the inner surface of the container. The container is tilted at a first angle determined in relation to the vertical and rotated relative to the tool at a first predetermined speed V, while heating said container to a predetermined temperature. The liquid coating material is uniformly applied to the inner surface of the container to obtain a uniform, substantially identical thickness.

The present invention relates to a process for coating, with a curable liquid material, at least a portion of the internal surface of a container elongated around an axis, suitable for containing products biocompatible with man and/or animals.

It also relates to a device implementing such a process and to a container obtained therewith.

Coating process is understood to mean the surface covering or affixing of a layer of material on the surface of an object formed of another material, in a way which is integral and lasting (that is to say, greater than several years). Such a coating then modifies the physical and/or chemical surface properties of this other material.

The invention has a particularly important although nonexclusive application in the field of the manufacture of bottles intended to receive and preserve processed foodstuffs, pharmaceutical products or cosmetic products.

It makes it possible in particular to minimize container/contents and/or environment/contents interactions, more particularly for storage in glass bottles, requiring the preservation of products in a neutral fashion for a fairly long time (for example several months).

Conventionally, neutral glass is understood to mean a glass which, over time, releases ions, for example sodium ions or other alkali metal and/or alkaline earth metal ions, in a very small amount into the liquid or product which is inside the container.

Very small amount is understood to mean a ratio of weight of the liquid contained and total weight of the extractable elements of less than 6 ppm.

Soda-lime glass, for example, is not neutral within the meaning of the Pharmacopeia.

It is thus known that, when a glass bottle is manufactured, it is necessarily brought to high temperatures.

The latter result in particular in a migration of the alkali metals (in the case of a silicate glass), which rise to the surface of the glass and/or to its immediate proximity, and in a manner sufficient to be subsequently exposed to the contents of the container.

In point of fact, the amounts of alkali metal, although generally very small, are harmful in the case of bottles intended to contain vaccines or active principles, which have to remain pure.

This is because the alkalinity may cause dangerous effects with regard to a pharmaceutical product, as a result of unacceptable reactions which might take place between the wall of the glass and the product.

Means for preventing disadvantages of this type by the use of sulfur dioxide and/or of difluoroethane or by treatment with heat on the line for production of the glass bottles, either with sulfur or with fluorine, are already known.

The sodium sulfate generated by such treatments (white film on the internal surface of the bottles) is subsequently washed with water before filling the containers.

These processes are complex, expensive and difficult to carry out, in particular as a result of the handling of toxic and/or polluting products.

It is also known (EP 2 414 300) to cover the internal wall of the bottle with a thin protective film, obtained by spraying the covering liquid with a nozzle introduced vertically into the container held vertical and in rotation with respect to one another.

There are disadvantages to all these processes.

In particular, they do not make possible great accuracy, in particular with regard to the shape of the outlines of the region of the surface to be coated or with regard to the thickness of the coating layer.

Thus, in the case of a vertical rotational axis, smears directed downward appear. In addition, a gradient of thickness in the coating layer which increases downward in the vertical direction is observed, which renders the protection uneven.

These smears and excess thicknesses are in particular greater at the junction between vertical and horizontal walls and are, for example, due to the formation of drops under the effect of gravitation during drying.

This results in a degraded aesthetic appearance of the final products, which is troublesome, indeed even absolutely unacceptable, in the field of luxury cosmetics.

The known solutions also result in costs because, in order to guarantee good covering, the amounts of material and the correlative drying times are necessarily increased.

Furthermore, for small-sized containers, the surfaces are difficult to reach with great accuracy.

The present invention is targeted at providing a process, a device and a bottle obtained by such a process, corresponding better than those previously known to practical requirements, in particular in that it does not use toxic products to passivate or protect the internal wall of the bottle, in that it does not require an aggressive treatment or obligatory rinsing before and/or after use, in that it allows the treatment of all types of containers, while bringing about fewer breakages or less damage than in the prior art, and in that the geometry of the coating layer is obtained with great accuracy and excellent evenness, both in thickness and in definition and/or resolution of the resulting pattern.

Greater accuracy is understood to mean values determined to ±100 nm in thickness for a layer and/or in length for a pattern, for example in a thin film.

In order to do this, the invention proposes to reduce and/or to better control the rate of trickling and/or of flow of the coating liquid over the internal wall than with the processes of the prior art.

It thus in particular provides an acquisition and a processing of the coating parameters (thickness and width) in a better regulated way.

One of the objects of the present invention is thus to implement these parameters with the abovementioned advantage and while overcoming the disadvantages of the prior art.

With this aim, it provides in particular a process for the coating of at least a portion of the internal surface of a container elongated around an axis O_{z}, suitable for containing products biocompatible with man and/or animals, with a curable liquid coating material, in which the container is positioned on a support with which it is rendered integral, a tool for application of the coating is introduced into the container and the coating liquid is affixed by the tool to at least a portion of the internal surface of the container,

characterized in that

the container is inclined by a first predetermined angle α with respect to the vertical,

the container is put in relative rotation with respect to the tool around the axis O_{z} at a first predetermined speed V, while heating it to a predetermined temperature,

and the liquid coating material is evenly affixed to the internal surface of the container so as to obtain a deposit with an even, substantially identical, thickness, as a function of the parameters of viscosity η of the liquid at the predetermined temperature, of the roughness R of the part of the surface of the container, of the angle α of inclination, of the rotational speed V and of the flow rate D for feeding with liquid material.

The relative rotation can originate either from the rotation of the container, the tool remaining stationary, or from the rotation of the tool, the container remaining stationary, or a mixture of the two.

Curable liquid material is understood here to mean a liquid material containing a solvent, a solid and resistant residual fraction of which remains after evaporation, with a mechanical behavior similar to that of plastic or glass.

The process according to the embodiment of the invention more particularly described here thus makes it possible to obtain a layer of even form and of homogeneous thickness, so that the resulting hydrolytic resistance of the container is sufficient to satisfy the standards at the date of filing of the present patent application and corresponding to the applications, in particular pharmaceutical applications, envisaged.

Conventionally, the hydrolytic resistance is measured before treatment, and after treatment, by determining the amounts of sodium oxide and of other alkali metal or alkaline earth metal oxides released during a treatment in an autoclave at 121° C. for 60 minutes, the measurements being, for example, subsequently carried out in a way known per se by flame spectrometry.

With the invention, it is thus found that subsequent releases, in particular as tested in a standardized fashion in an autoclave as described above, no longer make it possible to measure significant degrees of releases.

In advantageous embodiments, recourse is had, furthermore and/or in addition, to one and/or other of the following arrangements:

the angle α of inclination of the container is between 25° and 75°;

the angle α of inclination of the container is 45°;

the portion of the internal surface to be coated is heated by a heating means focused on said portion;

the portion of the internal surface is heated by a device which emits a focused beam reflected on a steerable mirror inserted into the container;

the tool is appropriate to be able to be inclined with respect to the axis of rotation of the container by a second angle α of between 0° and 30°;

the tool is a nozzle for spraying the coating liquid;

the nozzle is flexible or comprises a curved end portion;

the tool is a means for application of the liquid by padding;

the means for application by padding is a balloon arranged in order to expand between a first state of introduction into the container and a second state of application of the coating liquid;

the means for application by padding comprises a tank for feeding with coating liquid arranged in order to diffuse the liquid over the external surface of said means of application;

the process comprises a preliminary stage of filling the container with coating liquid and a stage of expulsion of the liquid by the tool comprising an injector of gas under pressure into the container.

The invention also provides a device implementing the process as described above.

The invention consequently provides a device for coating at least a portion of the internal surface of a container elongated around an axis O_{z}, suitable for containing products biocompatible with man and/or animals, with a curable liquid coating material comprising a support for receiving the container which is integral with the container and a tool for application of said coating liquid to at least a portion of the internal surface of the container and means for feeding the liquid material at a predetermined flow rate D, characterized in that, the support being arranged in order to incline the container by a predetermined first angle α, the device comprises means for rotating the container and/or the tool around the axis O_{z} at a predetermined speed V, means for heating the container to a predetermined temperature and means for insertion of the tool into the container, and in that it comprises calculation means arranged in order to control the speed V of the rotating means, the flow rate D for feeding with liquid, the predetermined temperature and the angle α of inclination of the support, as a function of the parameters of viscosity η of the liquid at said predetermined temperature and of the roughness R of the part of the surface of the container, so as to evenly deposit a layer with an identical or substantially identical thickness of liquid coating material over the internal surface of the container.

Advantageously, the tool is a flexible and/or curved nozzle.

Also advantageously, the tool is an extendable balloon.

The invention also provides a container obtained by the process described above.

It also relates to a container elongated around an axis O_{z} comprising a coating layer over at least a part of its internal surface, said layer being made of a curable material, characterized in that the difference in thickness of the coating layer at any two points of said coating layer is less than 200 nm.

It should be noted that, with the process according to the invention, the containers obtained exhibit improved properties of their internal surface, in particular of their thermal insulating properties, and also a better attractiveness and of greater abilities for protecting their contents with respect to ultraviolet radiation, as a result of a better screening ability of their walls.

It is thus possible to produce, via the coating layer, a barrier function to heat and/or to UV radiation, in addition to its resistance to releasing.

A better understanding of the invention will be obtained on reading the description which follows of embodiments given below as nonlimiting examples.

It is done with reference to the figures which accompany it, in which:

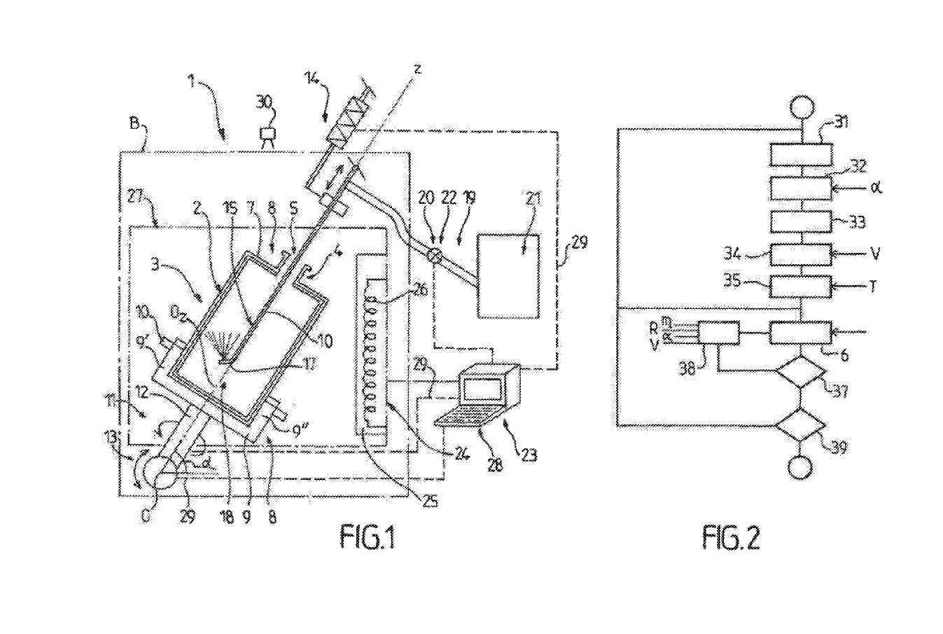

FIG. 1 diagrammatically shows a coating device according to a first embodiment of the invention.

FIG. 2 gives a flow diagram of the stages of the process according to the embodiment of the invention more particularly described here.

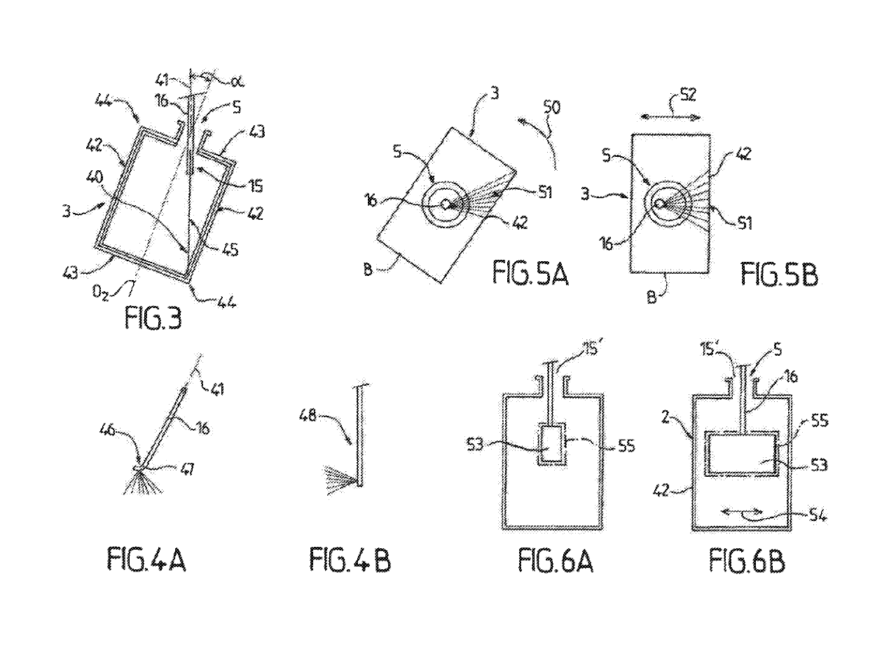

FIG. 3 is a side view in section showing the introduction of a spraying spray nozzle into a container, according to one embodiment of the invention.

FIGS. 4A and 4B show two embodiments of spray nozzles which can be used with the invention.

FIGS. 5A and 5B diagrammatically illustrate, in top view, a container and a spray nozzle inserted into said container, at two moments in the rotation of the container according to one embodiment of the invention.

For their part, FIGS. 6A and 6B are diagrammatic views in lateral section of a container equipped with padding means according to another embodiment of the invention, respectively in a contracted state for introduction and in an expanded state.

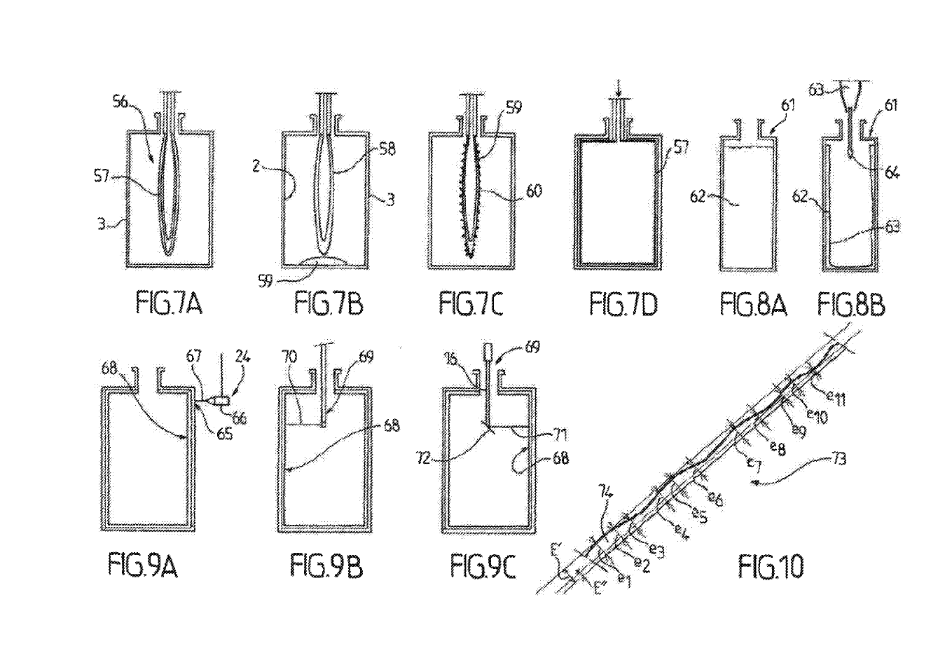

FIGS. 7A and 7D are lateral views in section showing the different stages of application of a layer of coating liquid by an inflatable pad according to another embodiment of the invention.

FIGS. 8A and 8B are lateral views in section of a container respectively in the state filled with coating liquid and then covered with a layer of coating liquid, after expulsion of the liquid by injection of gas, according to another embodiment of the invention.

FIGS. 9A to 9C show, in lateral section, containers equipped with means for baking the coating layer, according to three embodiments of the invention.

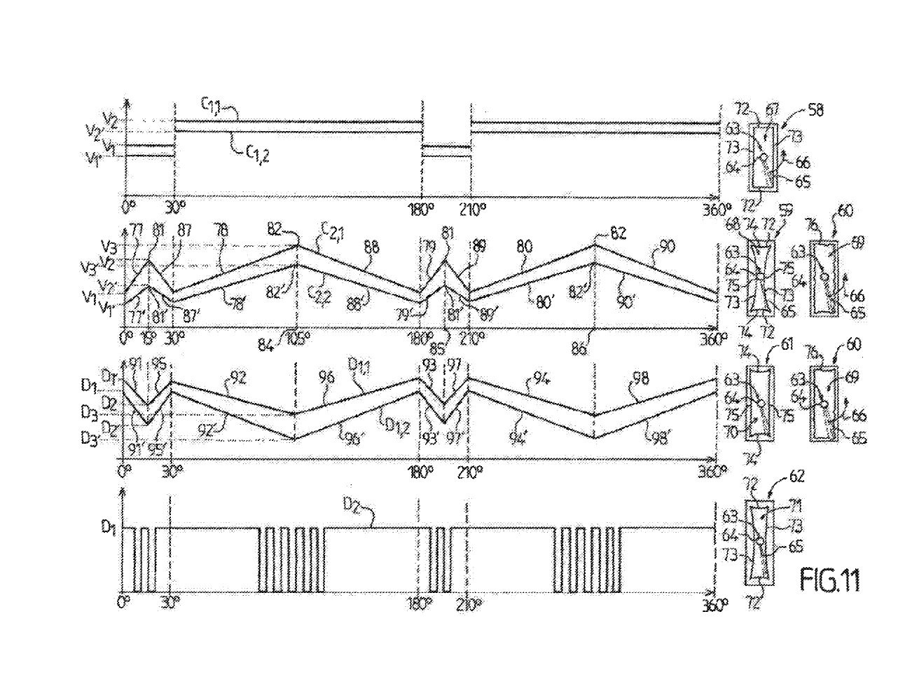

FIG. 10 diagrammatically shows a portion of container wall covered with a protective layer according to the invention, making it possible to illustrate the accuracy obtained with regard to the thickness of the layer of coating liquid according to the invention.

FIG. 11 shows a set of curves each corresponding to an embodiment of control law according to the invention.

FIG. 1 shows a device 1 for coating at least a portion of the internal surface 2 of a container 3, according to the embodiment of the invention more particularly described here.

The container 3 is, for example, a cylindrical glass bottle elongated around an axis O_{z}. It comprises, at one of its ends 4 (top end in the case of FIG. 1), an opening 5 as a bottle neck. The opening 5 of the bottle neck comprises a neck 6 with a smaller diameter than that of the container with the bottle.

The container 3 is suitable for containing products biocompatible with man and/or animals, that is to say compatible with ingestion and/or application to the human or animal body.

The device 1 comprises a support 8 for the container 3 (as dot-and-dash line in the figure), for example comprising a retention clamp 9 in the shape of a dish or of a U, the branches 9′, 9″ of which grip the base of the container 3 fixed via lateral screws 10.

Means 11 for rotating the container 3 around its axis O_{z} at a predetermined speed V are provided. The speed V can be unchanging or variable and regulated. More specifically, the means 11 comprise, for example, a rotating rod 12 for driving the support 8 which extends along the axis O_{z} and a motor 13 for driving in a way known per se.

The rod 12, support 8 and container 3 assembly is mounted on a frame B (also symbolized as a dot-and-dash line in FIG. 1) and can be inclined with respect to the horizontal by a first angle α, for example via a ratchet ball-and-socket joint movable in rotation around an axis perpendicular to the axis O_{z}.

The inclination α is adjustable between 20° and 80°, for example in this instance set at 45°.

It can be controlled manually or can be under the mastery of a system for rotating at a calculated angle, this being done by means known per se.

Means 14 for insertion of a tool 15 inside the container 3 are mounted on a frame B on the side of the bottle neck of the container 3.

The means 14 comprise a longitudinal shaft or tube 16 connected at its end to means D for longitudinal movement, such as a jack.

The action of the jack, which is integral with the tool 15, relocates the latter from an initial position external to the container 3 to an operating position internal to the container 3 along the axis O_{z}.

It thus makes possible a gradual, continuous or stepwise, descent of the tool 15 for application of the coating liquid to the internal surface 2 of the container 3.

In the embodiment of FIG. 1, the tool 15 is thus formed of the tube 16 equipped with a spray nozzle 17 at its distal end 18.

The nozzle brings about vaporization according to a predetermined solid angle for dispersion which depends on the ejection rate and pressure controlled in a way known per se.

The tube 16 is connected, at its opposite end, to a system 19 for dispensing coating liquid to be sprayed comprising means 20 for feeding, via a metering pump, with liquid material at a predetermined flow rate D.

The system 19 furthermore comprises a liquid tank 21 and means 22 for movement of the liquid (metering pump) arranged in order to regulate the flow rate D of the liquid via a calculator 23 which, as will be seen below, also controls the other actuators employed in the device.

The coating liquid is a curable liquid coating material, for example that obtained by a process known under the name Sol-Gel.

The Sol-Gel process comprises a stage of synthesis carried out starting from alkoxides of formula M(OR)ₙ, where M is a metal or silicon and R is an organic CₙH₂ₙ₊₁ alkyl group dissolved in a standard solvent.

The device 1 also comprises means 24 for heating the container known per se which make possible the rise in the temperature of a part of the internal surface 2 of the container 3 up to a predetermined temperature threshold. More specifically, the heating of the internal surface 2 is carried out by direct radiation from heating resistors 25 positioned outside the container or by diffusion around the wall of the container positioned in contact, for example with a heating muffle (not represented).

In one embodiment, the container 3 and the resistor 25 are substantially confined in one and the same chamber 27 so as to form an oven for homogeneous heating of the container.

The device 1 also comprises a computer 28 for digital control comprising the calculator 23.

These are connected via a data bus 29 and, in a way known per se, to the actuators of the device 1, namely to those of the clamp 9 for retention of the container 3, that is to say of the motor 13 for actuating in rotation and for positioning of the inclination of the container 3, to those of the means 14 for insertion of the tool 15 into the container 3 (jack), and also to those of the means 19, 20 for movement/feeding with liquid (pump, valve, nozzle) and heating means 24 (electrical resistors 25).

The calculator 23 is arranged in order to calculate, from the different set points imposed, a control law for each of the actuators and to consequently control them.

The control law will be described in detail subsequently, in particular with reference to FIG. 11.

The calculator 23 is thus arranged in order to control the speed V of the motor 13, the flow rate D for feeding with liquid and the predetermined heating temperature as a function of the angle α of the inclination of the support, of the parameters of viscosity η of the liquid at said predetermined temperature and of the roughness R of the part of the surface 2 of the container 3, so as to evenly deposit a layer with an identical or substantially identical thickness of liquid coating material on the internal surface 2 of the container 3.

In order to do this, the calculator 23 comprises a rewritable non-volatile memory (not represented) and is arranged in order to digitally process the data introduced by the operator at the time of the treatment and/or in order to take into account preregistered data (in said memory).

For example, the memory comprises preregistered data organized into tables, namely:

a table of numerical modeling of the geometry of the containers to be treated,

a table of the data for geometric modeling of a pattern for coating the internal face of the container (thickness of the layer, thickness of the line, pattern, and the like),

a table associating a value of viscosities η with a predetermined solution of coating materials at different temperatures, possibly according to the supplier,

a table of rate of flow along the internal wall of the container 3 of the coating liquid for a predetermined roughness of the wall, at different viscosities η at different rotation speeds and for different angles of inclination,

a table of treatment times as a function of the temperature, of the coating liquid and of the thickness of the coating layer desired.

Alternatively, some or all of the preregistered data can be measured rather than memorized, for example by the use of sensor means (temperature, pressure, and the like), of image capture means, such as a CCD video camera 30 associated with the appropriate electronic data processing, in a way known per se to a person skilled in the art.

In the continuation of the description, the same reference numbers will be used to describe identical or similar elements.

FIG. 2 shows the stages of the coating process according to another embodiment of the invention.

The process comprises a preliminary and optional stage (not represented) of passivation of the internal face of the container 3.

In one embodiment, the passivation is carried out by filling with aqueous extraction liquid, for example with water of R1 quality, and then emptying after a predetermined time.

In another embodiment, the container 3 is placed in an oven for a time of at least three hours at a predetermined temperature of more than 120° C. This operation is, for example, repeated twice.

This stage reduces the amount of ions released into the contents of the container, in particular when the coating layer does not cover all or most of the internal surface 2. It also prepares the internal face 2 for the adhesion of the coating layer.

After this optional stage, the process comprises a first stage 31 of supplying and fixing at least one container 3 to the support 8.

During this stage, parameters are also introduced by the operator into the calculator 23.

These parameters are in particular the geometric typology of the container 3, the roughness of its internal wall, the viscosity η of the liquid covering material, the pattern of the surface 2 to be coated and the thickness of the coating layer desired.

The process subsequently moves on to stage 32, where the container 3 is inclined by an angle α, by automatically ordering this inclination by introduction into the computer of the desired and/or calculated value α.

In the following stage 33, the jack 17 is ordered to move the tool 15 from a general initial position (position raised completely outside the container 3) to an initial coating position, that is to say a position introduced into the container 3. The start of the journey of the nozzle 15 for the coating is then initiated.

In stage 34, the support 8 and/or the container 3 are rotated around the axis O_{z} at a speed V. The rotational speed V is variable and, for example, between 1.5 rad/s and 20 rad/s, for example between 8 rad/s and 12 rad/s.

Alternatively, the introduction of the tool 15 can be carried out before the inclination or after the following stage of rotating the container.

During stage 35, the resistors facing the external surface of the container 3 are moved nearer and the external surface is heated to a controllable temperature T of between 125° C. and 250° C., for example of between 160° C. and 200° C.

Alternatively, the support 8 and the container 3 were placed in the chamber 27 or oven.

The calculator 23 then determines, as a function of the parameters introduced, the initial flow rate D of the gel and also the relative position of the tool 15 with respect to the container with monitoring by the video camera 30, for example.

The liquid coating material is then (stage 36) evenly affixed to the internal surface 2 of the container 3, so as to obtain a deposit with an even thickness, substantially identical at the spot chosen.

It should be noted that the flow rate D of the product is between 1 ml/min and 20 ml/min, for example between 1 ml/min and 3 ml/min.

A test (test 37) is then carried out with regard to the completion or not of the coating, and/or of the design and/or of the pattern desired on the internal surface.

During the covering, the parameters are regulated (stage 38) as a function of the control law and continuously recalculated.

The stage of affixing of the coating layer can be repeated a predetermined number of times n, for example three times, in particular in order to coat unconnected patterns and/or in order to change covering material.

The combined stages 31 to 37 can also be repeated a number of times n (test 39), in particular for the affixing of a layer of a second material.

The number n is, for example, greater than or equal to two, for example greater than or equal to three.

FIG. 3 shows the introduction of a tool 40 according to another embodiment of the invention.

The tool, substantially longitudinal, is in this instance introduced vertically into the container 3 by the opening 5 of the bottle neck, the axis 41 of the tube 16 of the tool 15 then forming an angle α of 30° with the axis O_{z} of inclination of the container 3.

The angle α is an angle of less than 45°, the inclination making it possible, for example, to render the junction between the vertical 42 and horizontal 43 walls of the container 3 and/or the corners 44 of the latter more accessible to the tool 15.

In the illustration of FIG. 3, the tool 15 comprises a spray nozzle 17 for the coating liquid, the corner 44 being at right angles to the tool 15 and consequently suitable for being sprayed by a vertical jet 45. The coating of the corner 44 of the container 3 can thus be better controlled.

FIGS. 4A and 4B respectively represent a nozzle 46 at the curved end 47 of the tube 16, with spraying inclined with respect to the axis 41 of the tube, and a nozzle 48 with radial spraying perpendicular to the axis of the tube.

The end 47 of the tube 16 can be flexible or stiff, the curving furthermore rendering the relatively inaccessible regions more reachable by the spray jet.

In another embodiment according to the invention represented in top view in FIGS. 5A and 5B, the support 8 for receiving the container 3 and the container 3 and/or the tool 15 can be put in relative movement in the horizontal plane.

This movement can be achieved by movement of the frame B of support 8 and/or by movement of the jack for insertion of the tool 15.

The movement in the horizontal plane can be ordered and monitored by the calculator 23.

More specifically, in FIG. 5A, the spray tube 16 of the type described with reference to FIG. 4B is moved down in the container along the axis O_{z} and then subjected to a relative rotation (arrow 50) with the bottle (i.e., the bottle or the tube rotates).

The flow rate D of the nozzle is in this instance controlled so that the variation in the flow rate D compensates, for a predetermined solid angle 51 of spraying of the nozzle, for the variable distance from the wall to the nozzle.

In other words, the amount of liquid sprayed per unit of surface area is adjusted in order to simulate a substantially constant distance.

In order to do this, and for example, the imaging means (cf. FIG. 1) continually acquire the nozzle/wall distance and transmit it to the calculator for regulation of the flow rate D.

In FIG. 5B, the compensation for the distance between tube 16 and corresponding nozzle and wall 42 is carried out by the relative movement (arrow 52) in the horizontal plane of the nozzle with respect to the container. More specifically, the tube 16 is no longer coaxial but offset and in movement parallel to the axis O_{z}. In this embodiment, the distance between nozzle and wall is then the parameter which is modified and the flow rate D can then remain substantially constant.

Substantially is understood here to mean a variation of less than 10% in the nominal spraying flow rate.

The embodiments according to the invention described in correspondence with FIGS. 5A and 5B can be combined.

FIGS. 6A and 6B show two successive stages of use of a tool 15′ according to another embodiment of the invention using application means in the pad form 53.

The pad can, for example, be formed by a parallelepipedal part which can expand (arrow 54) between a retracted volume (FIG. 6A), allowing it to be introduced into the container, and an expanded volume (FIG. 6B) for application. It is covered with a layer 55 of liquid and of transfer of the latter by pressing against the facing wall 42.

Application can be carried out by rotation about a parallel axis off-centered with respect to the axis O_{z} of the container 3, or else with an angle with respect to the axis O_{z}.

In this way, the layer 55 of the part 53 comes into contact with the internal wall 2 of the container 3 and deposits the coating material there.

In one embodiment, the pad is cylindrical and itself also movable in rotation, which allows it to better rub over the internal surface of the container during the relative rotation of the tool and of the container in order to deposit the liquid on the internal surface of the latter.

The layer 55 of the means 53 for absorption of liquid operates either by impregnation prior to the transfer or via the tank 21 for feeding continuously with coating liquid, arranged in order to diffuse the liquid over the external surface 45 of the layer 55 in a way known per se.

FIGS. 7A to 7D show the stages of implementation of another embodiment of the impregnation system.

In these embodiments, the means for application by padding 56 is an extendable oblong balloon 57, arranged in order to expand between a first state of introduction into the container 3 (FIG. 7A) and a second state of application of the coating liquid (FIG. 7D).

In the embodiment of FIG. 7B, the balloon 58 is introduced deflated after an amount 59 of coating material has been introduced into the bottom of the container 3.

The balloon 58 is subsequently inflated inside and the pressure of the balloon on the internal wall 2 of the container 3, which then matches the internal shape of the container, causes the material 59 to rise, by pressure and capillary action, along the internal face of the walls 2.

In another embodiment represented in FIG. 7C, the balloon 59 comprises a membrane which is porous for the liquids and/or comprises surface capillary channels 60 for conveying the liquid over its external surface arranged in order to diffuse the liquid there.

The balloon 59 is thus partially covered with material prior to the moment of inflating it in order to apply the liquid to the internal wall 2.

Another impregnation embodiment has been shown in FIGS. 8A and 8B.

The container 61 is advantageously cylindrical, of elongated shape (tubular or with a small diameter d with respect to its height h, i.e. advantageously d<h/10, and for example with a maximum diameter of less than 20 mm, for example 10 mm).

A first stage of filling (cf. FIG. 8A) of the slantwise container 61 with the liquid 62 up to a threshold level is provided. A second stage of expulsion of the liquid from the container (cf. FIG. 8B) after impregnation is carried out at the end by the tool.

The tool 62 is a gas injector 63, for example a pressurized air injector. It is placed at right angles to the opening of the container 61 and at a distance of a few millimeters from the opening (for example 5 mm).

The gas is violently injected at 64 under high pressure, for example between 1.5 and 10 bar.

Under the effect of the jet of gas, the excess liquid (that is to say, liquid not of use in the formation of the layer 63 of material) is expelled from the container which turns.

In this embodiment, the data for pressure and duration of the injection are preregistered in the memory of the computer, so that the calculator 23 determines the parameters necessary for the adhesion of the layer 63.

The viscosity η, the rotational speed V and the roughness of the wall determine the application times for allowing good adhesion of the layer 63, and also the sufficient drying conditions (time and temperature).

This embodiment is advantageous in particular when the complete coating of the internal surface 2 of the container 61 is desired.

Three modes of heating the part of the wall have been represented diagrammatically in FIGS. 9A to 9C.

FIG. 9A shows means 24 for heating the internal wall 2, via an emitter 66 of a focused beam 67. Such an emitter is, for example, a projected infrared source or a CO₂ laser.

The emitter 66 is facing the external surface 68 of the wall of the container. The heat is then either diffused by the constituent medium of the wall of the container 3 and then increases the temperature of the internal surface 2 of said wall or, according to the wavelength chosen, passes through the constituent material of the wall and will directly excite the affixed curable liquid layer 68.

Another embodiment of the invention is presented in FIG. 9B. In this instance, an emitter 69, for example similar to that of FIG. 9A, is directly introduced into the container 3. The infrared (IR) beam or the laser beam 70 will then directly excite and heat the region of the internal surface 2 coated with the liquid layer 68.

FIG. 9C is similar to FIG. 9B but shows a beam 71 reflected by a steerable mirror 72 inserted into the container 3 and fixed, for example, to the tube 16 of the tool.

In a specific embodiment, it is possible, at the same time as the application of the layer 68 by a spraying means 15 of the type described above, to coagulate the liquid by baking/heating with a laser as described above) and to thus reduce the runoffs and/or smears by very rapidly solidifying the sprayed material after its ejection from the tool 15 and its application to the wall.

A portion 73 of wall and of the corresponding coating layer obtained by the device 1 according to the invention is represented in FIG. 10.

The layer 74 comprises differences in thickness (e1, . . . , e11).

These differences in thickness are, for example, due to the surface defect of the wall.

With the use of a process and/or of a device 1 according to the invention, the difference (e1-e11) in thickness of the coating layer 74 at any two points (e1, . . . , e11) of said coating layer is less than 1 μm, for example less than 0.5 μm.

More specifically, on considering, for the surface portion under consideration, a sampling of the thickness of the layer, the difference of thickness under consideration between the lowest value (e11) of said sampling and the highest value (e1) is less than a threshold value S (S≦0.2 μm).

Sampling is understood here to mean a collection (e1, . . . , e11) of data representative of the thickness measured at a predetermined geometric interval, for example a regular geometric interval, along at least one defined route of the surface of the coating layer 74.

Examples of the implementation of the control law for coating with a device according to FIG. 1 will now be described, with reference to FIG. 11.

The latter shows, in the case in point, seven examples of curves for control law implementation which can be applied to corresponding containers 58, 59, 60, 61 and 62.

The first curves C_{1,1} and C_{1,2}; C_{2,1} and C_{2,2} correspond to commands for relative rotational speed between nozzle and container at a constant injection pressure, making it possible to obtain a homogeneous deposit over the internal walls respectively of the containers 58 (C_{1,1} and C_{1,2}), 59 (C_{2,1}) and 60 (C_{2,2}) via a nozzle 64 introduced by the bottle necks 63 in order to generate a jet 65.

The following three curves D_{1,1} and D_{1,2}; D₂ correspond to controls of pressure of injection by the nozzle, at constant rate, for spraying flow rates D, this being the case respectively for the containers 60 (D_{1,1}), 61

(D_{1,2}) and 62 (D₂).

More specifically, the curves show the change in the rate V or in the pressure of flow rate D (on the ordinate) as a function of the angular position (on the abscissa) of the container with respect to the spray jet 65 of the nozzle 64 over a complete rotation of the container (arrow 66).

In all the embodiments to which said curves correspond, the container 58, 59, 60, 61, 62 is parallelepipedal and substantially of unchanging or changing rectangular internal section 67, 68, 69, 70, 71.

The nozzle 64 is introduced into the container 58, 59, 60, 61, 62 in a manner which is centered with respect to the internal walls 72, 73 of the container.

Centered is understood to mean positioned on the center of gravity of the internal section 67, 68, 69, 70, 71 of the container at the height considered for the introduction of the nozzle 64.

The nozzle 64 comprises an opening for the expulsion of a spray jet 65 of coating liquid, the jet being of substantially conical shape.

In the initial position for introduction of the nozzle 64, the spray jet 65 reaches a corner of the container 58, 59, 60, 61, 62 and the direction of the height of the cone of the jet 65 corresponds to the angle 0°.

The angular sweeping of the nozzle 64 and/or of the container 58, 59, 60, 61, 62 describes the angular ranges from 0° to 30° P1, from 30° to 180° P2, from 180° to 210° P3 and from 210° to 360° P4, which correspond to the sweeping of the segments 72 with widths of the rectangular internal section 67, 68, 69, 70, 71 for P1 and P2 and of the segments 73 with lengths of the internal section 67, 68, 69, 70, 71 for P2 and P4.

In the embodiment corresponding to the curves C_{1,1} and C_{1,2}, the section of the container 58 is strictly rectangular and the internal volume of the container then presents, to the jet 65 of the nozzle 64, flat walls 72, 73.

The first curves for speed C_{1,1} and C_{1,2} follow curves formed by stationary phase between two predetermined speed values respectively V₁; V₂ and V_{1′}; V_{2′}, with V₁ and V_{1′} respectively lower than V₂ and V_{2′} corresponding to each of the internal walls.

The speed is thus constant over a given angular range.

The speed is equal to V₁ (respectively V_{1′}) over the first range P1 corresponding to a small side, V₂ (respectively V_{2′}) over the second range P2 corresponding to a large side, V₁ (respectively V_{1′}) over the third range P3 (small size) and V₂ (respectively V_{2′}) over the fourth range P4 (large side).

The variations in rotational speed of the nozzle 64, by following the rotational speeds V of the curves C_{1,1} or C_{1,2}, thus compensate for the variations in distance between the nozzle 64 and the walls 72, 73 during the rotation of the rectangular internal section 67, 68, 69, 70, 71 of the container 58, 59, 60, 61, 62.

In the embodiment corresponding to the curves C_{2,1} and C_{2,2}, the internal section 68, 69 of the container 59, 60 is in this instance substantially rectangular and exhibits bent sides 72, 73, for example the sides of the section are convex towards the inside of the top container 74, 75, or the internal walls of the container exhibit undulations 76.

In this instance, the speeds V follow, with regard to each angular range P1 to P4, an ascending triangular curve, that is to say a first curve segment 77, 78, 79, (respectively 77′, 78′, 79′, 80′) with an increasing slope up to a peak 81, 82 (respectively 81′, 82′) substantially at half the range considered, 83 (approximately) 15°, 84 (approximately 105°, 85 (approximately 195° and 86 (approximately 285°, and a second curve segment 87, 88, 89, 90 (respectively 87′, 88′, 89′, 90′) with a decreasing slope down to the end of the range considered.

The peaks 81, 82 (respectively 81′, 82′) have an abscissa which corresponds, for the nozzle, to the angular position in which the jet is in the direction of a top 74, 75 of the convex sections 68, 70, 71.

The starting point (angle 0°) of the curves C_{2,1} and C_{2,2} corresponds to a predetermined speed V₁ (or V_{1′}), the vertex 81, 81′ of the first range P1 corresponding to a predetermined speed V₂ (or V_{2′}) and the vertex 82, 82′ of the second range P2 corresponding to a predetermined speed V₃ (or V_{3′}).

The first angular range P1 is identical to the third range P3 and the second range P2 is identical to the fourth range P4, and V₁<V₂<V₃ or V_{1′}<V_{2′}<V_{3′}).

In this embodiment, the acceleration in the rotation of the nozzle makes it possible to compensate for the bent nature of the wall and/or the difference in nozzle/wall distance between the spraying of the corner and the spraying of the middle of the wall, by more rapidly sweeping the surfaces closest to the nozzle.

For example, the sweeping speed around each vertex 81, 82 corresponds to the maxima of the speed V₂ or V₃ over the angular range considered.

With reference to the curves for pressure of flow rate D_{1,1} and D_{1,2}, the container is in this instance the same or substantially the same as that corresponding to the embodiments of the curves for speed C_{2,1} and C_{2,2}.

The curves for flow rate D_{1,1} and D_{1,2} for pressure of the flow rate D are of symmetrical shape with respect to an axis along the abscissa to the speed curves respectively C_{2,1} and C_{2,2}.

More specifically, over each angular range P1 to P4, the pressure of the spraying flow rate D follows a descending triangular curve, that is to say a first curve segment 91, 92, 93, 94 (respectively 91′, 92′, 93′, 94′) as a decreasing slope as far as substantially half 83, 84 of the range considered and a second segment 95, 96, 97, 98 (respectively 95, 96′, 97′, 98′) with an increasing slope as far as the end of said range.

The initial flow rate is D₁ (or D_{1′}), the minimum flow rate over the first angular range P1 and the third angular range P3 is D₂ (or D_{2′}) and the minimum flow rate over the second range P2 and the fourth range P4 is D₃ (or D_{3′}) with D₁>D₂>D₃ (or D_{1′}>D_{2′}>D_{3′}).

In the embodiment represented on the curve of flow rate D₂, the control of the flow rate D corresponds to an all or nothing control, i.e. between a flow rate D₁ and a zero flow rate.

Control is thus carried out in a stepped or pulsed manner with a predetermined cyclic ratio.

Over each angular range P1 to P4, when the rotational angle of the nozzle 64 is substantially that of half of the range 83, 84 and when the nozzle is thus at the minimum distance between it and the sprayed wall, spraying is cut off (stopped) in a stepped or pulsed manner.

The cut-offs and/or pulses are substantially centered around half of each range 83, 84 and are symmetrical with respect to it.

Two cut-off pulses are symmetrically distributed for the first P1 and third P3 angular ranges and five for the second P2 and fourth P4 ranges.

In this way, the mean flow rate is appropriate to the geometry of the wall of the container facing the nozzle.

The curves represented in FIG. 11 are defined by segments but might be defined by curved sections, for example following a portion of sinusoidal or polynomial form.

In the embodiments more particularly described here, they are in addition periodical with a period of 180°, which corresponds to the theoretical symmetry of the rectangular internal section of the container.

The choice between the different control law curves can be made in a fixed or a priori manner and before the covering operation or be modified during the operation at each new section.

For example, in one embodiment, a sensor, for example an optical sensor, such as a high definition video camera, acquires a two- or three-dimensional image of the internal surface and transmits it to the calculation means.

Such a measurement can be made on each bottle or by homogeneous batch of bottles.

The calculation means then choose, for each section, the curve profile and/or the values characteristic of each curve (the initial speeds, the speed and the number and the positions of the peaks, and the like).

Each speed or pressure of the flow rate curve represents, by itself alone, a control law but it can also be combined with one another to form another control law embodiment.

For example, it may be desired to compensate for the deformities of the specific conformation of the wall and/or its geometric imperfections resulting in a difference in distance between the nozzle and the wall or corner to be sprayed, by simultaneously changing speed and pressure of the flow rate.

For example, the two curves can be changed in an opposite manner. This symmetry of behavior makes it possible to have a spraying over the surface which is homogeneous in amount.

The speeds V₁, V₂ and V₃ (and V_{1′}, V_{2′} and V_{3′}), the flow rates D₁, D₂, D₃ (and D_{1′}, D_{2′}, D_{3′}) and the cyclic ratios are unchanging or variable and adjusted or recalculated, for example at each descent of the nozzle and at each corresponding new horizontal section.

The viscosity η, the temperature T of the surface of the container, the roughness R and the angles of inclination α of the bottle and of the nozzle with respect to the bottle play a part, for example, in this embodiment for the definition of the initial speed values and the value of the peaks, of the flow rates D and of the cyclic ratios.

The values of viscosity η, temperature T of the surface of the container, roughness R and angle of inclination α1 and α2 follow, for example, related curves of influence of the values of rotational speed and/or of flow rate, for example:

For the viscosity η, the higher it is, the higher also are the speeds V₁ to V₃ and the higher the pressures of flow rate D₁ to D₃ and/or the lower the cyclic ratio and the higher the frequency.

For the temperature T and the roughness R, the influence on the speeds V, flow rate D and cyclic ratio is the same as with respect to the viscosity η.

For the inclinations, the influence is the reverse of that of the viscosity η.

Of course, it is not departing from the invention to define a different number of angular ranges and/or of vertices of the triangles, for example in order to be appropriate to the geometry of the section of the container.

As is obvious and as also results from the above, the present invention is not limited to the embodiments more particularly described. On the contrary, it encompasses all the alternative forms thereof and in particular those where the tool is a brush consisting of bristles which may or may not be retractable, with or without a liquid tank, those where the tool comprises a part for application and an absorbing part of the blotter type for the excess, those where the container 3 is oriented with the opening 5 downward, those where several containers are treated at the same time or those where the container 3 is in a material other than glass, such as plastic, metal, such as aluminum, or ceramic.

1. A process for the coating of at least a portion of the internal surface of a container elongated around an axis O_{z} with a curable liquid coating material, in which the container is positioned on a support with which it is rendered integral, a tool for application of the coating is introduced into the container, the container is put in relative rotation with respect to the tool around the axis O_{z} at a first predetermined speed V, while heating the container to a predetermined temperature, and the coating liquid is affixed by the tool to at least a portion of the internal surface of the container, wherein:
the container is arranged and suitable for containing and for preserving products biocompatible with man and/or animals,
the container is inclined by a first predetermined angle α with respect to the vertical,
and the liquid coating material is evenly affixed to the internal surface of the container by a spray nozzle, according to a control law which is a function of the parameters of viscosity η of the liquid at the predetermined temperature, of the roughness R of the part of the surface of the container, of the geometric typology of the container, of the angle α of inclination, of the rotational speed V and of the flow rate D for feeding with liquid material, said speed and said flow rate being regulated so as to obtain a deposit with an even, substantially identical, thickness, for container/contents protection.

2. The process as claimed in claim 1, wherein the angle α of inclination of the container is between 25° and 75°.

3. The process as claimed in claim 1, wherein the angle α of inclination of the container is 45°.

4. The process as claimed in claim 1, wherein the portion of the internal surface to be coated is heated by a heating means focused on said portion.

5. The process as claimed in claim 4, wherein the portion of the internal surface is heated by a device which emits a focused beam reflected on a steerable mirror inserted into the container.

6. The process as claimed in claim 1, wherein the tool is appropriate to being able to be inclined with respect to the axis of rotation of the container by a second angle α2 of between 0° and 30°.

7. (canceled)

8. The process as claimed in claim 6, wherein the nozzle is flexible or comprises a curved end portion.

9-12. (canceled)

13. A container for the storage of products biocompatible with man and/or animals, elongated around an axis O_{z} and comprising a coating layer on at least a portion of its internal surface, said layer being made of a curable material and being obtained by the process as claimed in claim 1, wherein the difference in thickness of the coating layer at any two points of said coating layer is less than 1 μm.

14. A device for coating at least a portion of the internal surface of a container elongated around an axis O_{z} with a curable liquid coating material comprising a support for receiving the container which is integral with the container and a tool for application of said coating liquid to at least a portion of the internal surface of the container and means for feeding the liquid material at a predetermined flow rate D, the device comprising means for rotating the container and/or the tool around the axis O_{z} at a predetermined speed V, means for heating the container to a predetermined temperature and means for insertion of the tool into the container, wherein,
the container is arranged for and suitable for containing products biocompatible with man and/or animals,
the support is arranged in order to incline the container by a predetermined first angle α,
the tool is a spray nozzle,
and comprising calculation means arranged for controlling and regulating the speed V of the rotating means, the flow rate D for feeding the liquid and the predetermined temperature, as a function of the angle α of inclination of the support, of the parameters of viscosity η of the liquid at said predetermined temperature, of the roughness R of the part of the surface of the container and of the geometric typology of the container, so as to evenly deposit a layer with an identical or substantially identical thickness of liquid coating material over the internal surface of the container, so as to obtain a deposition.

15. The device as claimed in claim 14, wherein the tool is a flexible and/or curved nozzle.

16. (canceled)
